(19) United States
(12) Patent Application Publication
(10) Pub. No.: US 2003/0162068 A1
(43) Pub. Date: Aug. 28, 2003

(54) Anode material for electrochemical cells

(76) Inventors: James D. Wilson, Brooklyn, NY (US); Muguo Chen, South Salem, NY (US)

Correspondence Address: Reveo, Inc., 85 Executive Blvd., Elmsford, NY, 10523, US

(21) Appl. No.: 10/283,016

(22) Filed: Oct. 29, 2002

Related U.S. Application Data
(60) Provisional application No. 60/340,697, filed on Oct. 29, 2001.

(51) Int. Cl. H01M 12/06; H01M 4/62

(52) U.S. Cl. 429/27; 429/212; 429/217

(57) ABSTRACT

An anode material for a metal air electrochemical cell is provided. The anode material comprises metal and/or metal oxide particles and a polymer electrolyte, particularly a polymer matrix material including electrolyte supported within the molecular structure of the polymer matrix material. Additionally, a metal air electrochemical cell is provided, using the anode material an air cathode, and a separator between the anode material and the air cathode.

### RELATED APPLICATIONS

The present application claims priority to U.S. Provisional Patent Application Serial No. 60/340,697 filed on Oct. 29, 2001 entitled “Metal Air Electrochemical Cell and Anode Material for Electrochemical”, which is hereby incorporated by reference in its entirety.

### BACKGROUND OF THE INVENTION

1. Field of the Invention

The present invention relates to metal air electrochemical cells. More particularly, the present invention relates to an anode material for use with metal air electrochemical cells.

2. Description of the Prior Art

Electrochemical power sources are devices through which electric energy can be produced by means of electrochemical reactions. These devices include metal air electrochemical cells such as zinc air and aluminum air batteries. Such metal electrochemical cells generally employ an anode comprised of a solid metal or an admixture including metal particles that are contained in the cell and converted to a metal oxide during discharge. The anode is generally formed of metal or metal particles immersed in electrolyte. The cathode generally comprises a oxygen reducing catalyzed gas diffusion substrate. The electrolyte is usually a caustic liquid that is ionic conducting but not electrically conducting.

Metal air electrochemical cells have numerous advantages over traditional hydrogen-based fuel cells. In particular, the fuel used to supply energy from metal air electrochemical cells is virtually inexhaustible. Typical metal air electrochemical cells use zinc, which is plentiful and can exist either as the metal or its oxide. Other forms of energy can be used to convert the metal from its oxide product back to the metallic fuel form (i.e., recharge the material). The fuel of the metal air electrochemical cells may be solid state or in the form of a paste, therefore, it is generally safe and easy to handle and store. In contrast to hydrogen-oxygen electrochemical cells, which use methane, natural gas, or liquefied natural gas to provide a source of hydrogen, and potentially emit polluting gases, the metal air electrochemical cells results in zero emission. Generally, metal air electrochemical cells are capable of delivering higher output voltages (1-3 Volts) than conventional fuel cells (<0.8 V).

Problems of metal air electrochemical cells include the management and maintenance of liquid electrolytes, and limited cathode lifetime due to the liquid environment. One approach to mitigating or solving these problems involves development of solid-state electrochemical cells. Conventional efforts to fabricate solid solid-state cells have focused on immobilizing liquid electrolytes with the incorporation of gelling agents.

Further, relatively low current density in certain types of solid solid-state metal air cells may relate to limited surface area contact between the metal fuel and the ionic conducting media. Additionally, relatively low capacity of solid state metal air cells is generally related to anode passivation during cell operation.

While some existing solid state metal air cells are generally suitable for their intended purposes, there nonetheless remains a need for improved solid state metal air electrochemical cells.

### SUMMARY OF THE INVENTION

The above-discussed and other problems and deficiencies of the prior art are overcome or alleviated by the several methods, compositions, and apparatus of the present invention, wherein an anode material for metal air electrochemical cells is provided. The anode material comprises metal or metal oxide particles and a polymer supported electrolyte media, particularly a polymer matrix material including electrolyte supported within the molecular structure of the polymer matrix material. Additionally, a metal air electrochemical cell is provided, using a quantity of the anode material, an air cathode, and a separator electrically isolating the anode and the air cathode.

The above-discussed and other features and advantages of the present invention will be appreciated and understood by those skilled in the art from the following detailed description and drawings.

### BRIEF DESCRIPTION OF THE DRAWINGS

Numerous other advantages and features of the present invention will become readily apparent from the following detailed description of preferred embodiments when read in conjunction with the accompanying drawings, wherein:

FIG. 1 is a schematic representation of an embodiment of a metal air electrochemical cell.

### DETAILED DESCRIPTION OF THE ILLUSTRATIVE EMBODIMENTS

An anode material for a metal air electrochemical cell is provided. The anode material comprises metal or metal oxide particles and a polymer supported electrolyte media. Additionally, a metal air electrochemical cell is provided, using a quantity of the anode material, an air cathode, and a separator electrically isolating the anode and the air cathode.

Referring now to the drawings, an illustrative embodiment of the present invention will be described. For clarity of the description, like features shown in the figures shall be indicated with like reference numerals and similar features as shown in alternative embodiments shall be indicated with similar reference numerals.

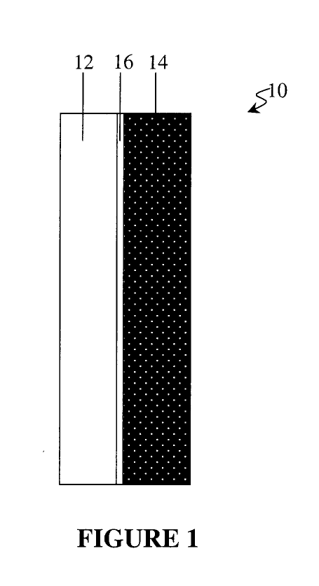

FIG. 1 is a schematic representation of an electrochemical cell 10. Electrochemical cell 10 may be a metal oxygen cell, wherein the metal is supplied from an anode 12 and the oxygen is supplied to an oxygen cathode 14. The anode 12 and the cathode 14 are maintained in electrical isolation from one another by a separator 16. The shape of the cell and of the components therein is not constrained to be square or rectangular; it can be tubular, circular, elliptical, polygonal, or any desired shape. Further, the configuration of the cells components, i.e., vertical, horizontal, or tilted, may vary, even though the cell components are shown as substantially vertical in FIG. 1.

Oxygen from the air or another source is used as the reactant for the air cathode 14 of the metal air cell 10. When oxygen reaches the reaction sites within the cathode 14, it is converted into hydroxyl ions together with water. At the same time, electrons are released to flow as electricity in the external circuit. The hydroxyl travels through the separator 16 to reach the metal anode 12. When hydroxyl reaches the metal anode (in the case of an anode 12, for example, comprising zinc), zinc hydroxide is formed on the surface of the zinc. Zinc hydroxide decomposes to zinc oxide and releases water back to the alkaline solution. The reaction is thus completed.

The anode reaction is:

Zn+4OH⁻→Zn(OH)₄²⁻+2e (1)

Zn(OH)₄²⁻→ZnO+H₂O+2OH⁻ (2)

The cathode reaction is:

1/2O₂+H₂O+2e→2OH⁻ (3)

Thus, the overall cell reaction is:

Zn+1/2O₂→ZnO (4)

The anode 12 generally comprises a metal constituent and an ionic conducting medium. The ionic conducting medium comprises a polymer matrix material including an aqueous electrolyte supported by the molecular structure of the polymer matrix material. The electrolyte generally comprises ionic conducting materials such as a solution of KOH, NaOH, LiOH, other materials, or a combination comprising at least one of the foregoing electrolyte media. Particularly, the electrolyte may comprise aqueous electrolytes having a concentration of about 5% ionic conducting materials to about 55% ionic conducting materials, preferably about 10% ionic conducting materials to about 50% ionic conducting materials, and more preferably about 30% ionic conducting materials to about 45% ionic conducting materials. Other electrolytes may instead be used, however, depending on the capabilities thereof, as will be obvious to those of skill in the art.

The metal constituent may comprise mainly oxidizable metals such as zinc, calcium, lithium, magnesium, ferrous metals, aluminum, oxides of at least one of the foregoing metals, and combinations and alloys comprising at least one of the foregoing metals. These metals having dimensions from about 0.1 microns to about 1 centimeter, preferably about 1 micron to about 3 millimeters, and more preferably about 75 microns to about 425 microns. During conversion in the electrochemical process, the metal is generally converted to a metal oxide. The metal constituent generally comprises a sufficient amount for desired electrical capacity. Generally, the metal constituent comprises about 10% to about 90% of the volume of the anode material, preferably about 20% to about 80%, and more preferably about 40% to about 60%.

The electrolyte generally comprises polymer supported electrolyte media to provide a path for hydroxyl to reach the metal constituent. Generally, an ion conducting amount of electrolyte is provided in anode 12. Preferably, sufficient electrolyte is provided to maximize the reaction and depth of discharge.

Exemplary polymer-based electrolyte materials or precursors are disclosed in copending: U.S. patent application Ser. No. 09/259,068, entitled “Solid Gel Membrane”, by Muguo Chen, Tsepin Tsai, Wayne Yao, Yuen-Ming Chang, Lin-Feng Li, and Tom Karen, filed on Feb. 26, 1999; U.S. Pat. No. 6,358,651 entitled “Solid Gel Membrane Separator in Rechargeable Electrochemical Cells”, by Tsepin Tsai, Muguo Chen and Lin-Feng Li, granted Mar. 19, 2002; U.S. Ser. No. 09/943,053 entitled “Polymer Matrix Material”, by Robert Callahan, Mark Stevens and Muguo Chen, filed on Aug. 30, 2001; and U.S. Ser. No. 09/942,887 entitled “Electrochemical Cell Incorporating Polymer Matrix Material”, by Robert Callahan, Mark Stevens and Muguo Chen, filed on Aug. 30, 2001; all of which are incorporated by reference herein in their entireties. Other ionic conducting polymeric materials may instead be used, however, depending on the capabilities thereof.

Feng Li, granted Mar. 19, 2002; U.S. Ser. No. 09/943,053 entitled “Polymer Matrix Material”, by Robert Callahan, Mark Stevens and Muguo Chen, filed on Aug. 30, 2001; and U.S. Ser. No. 09/942,887 entitled “Electrochemical Cell Incorporating Polymer Matrix Material”, by Robert Callahan, Mark Stevens and Muguo Chen, filed on Aug. 30, 2001; all of which are incorporated by reference herein in their entireties. Other ionic conducting polymeric materials may instead be used, however, depending on the capabilities thereof.

In one embodiment, a polymer matrix material comprises a polymerization product of one or more monomers selected from the group of water soluble ethylenically unsaturated acids and acid derivatives. The product also may include a water soluble or water swellable polymer, which acts as a reinforcing element. In addition, a chemical polymerization initiator (listed below) may optionally be included. The electrolyte may be added prior to polymerization of the above monomer(s), or after polymerization. For example, in one embodiment, electrolyte may be added to a solution containing the monomer(s), an optional polymerization initiator, and an optional reinforcing element prior to polymerization, and it remains embedded in the polymeric material after the polymerization. Alternatively, the polymerization may be effectuated without the electrolyte, for example, using water or other species to define the shape of the material, wherein electrolyte is substituted for at least a portion of the water or other shape defining species.

The water soluble ethylenically unsaturated acids and acid derivatives may generally have the following formula:

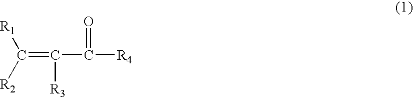

R1, R2, and R3 may be independently selected from, but are not limited to, the group consisting of H, C, C2-C6 alkanes, C2-C6 alkenes, C2-C6 alkynes, aromatics, halogens, carboxylic acid derivatives, sulfates and nitrates;

R4 may be selected from, but is not limited to, the group consisting of NR5, NHR5, NH2, OH, H, halides including but not limited to Cl and Br, OR5, and carboxylic acid derivatives, wherein R5 may be selected from the group consisting of H, C, C2-C6 alkanes, C2-C6 alkenes, C2-C6 alkynes, and aromatics.

Such ethylenically unsaturated acids and derivatives having the general formula (1), include, but are not limited to, methylenebisacrylamide, acrylamide, methacrylic acid, acrylic acid, fumaramide, fumaric acid, N-isopropylacrylamide, N, N-dimethylacrylamide, 3,3-dimethylacrylic acid, maleic anhydride, and combinations comprising at least one of the foregoing ethylenically unsaturated acids and derivatives.

Other ethylenically unsaturated acids and derivatives monomers having readily polymerizable groups may be used as the first type of monomer, depending on the desired properties. Such monomers include, but are not limited to, 1-vinyl-2-pyrrolidinone, the sodium salt of vinylsulfonic acid, and combinations comprising at least one of the foregoing ethylenically unsaturated acids and derivatives.

Generally, the first type of monomer comprises about 5% to about 50%, preferably about 7% to about 25%, and more preferably about 10% to about 20% by weight, of the total monomer solution (prior to polymerization).

Further, a second type of monomer or group of monomers is provided, generally as a crosslinking agent during the polymerization. Such a monomer is generally of the formula:

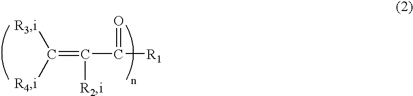

wherein i=1→n, and n≧2;

R_{2,i}, R_{3,i}, and R_{4,i} may be independently selected from, but are not limited to, the group consisting of H, C, C2-C6 alkanes, C2-C6 alkenes, C2-C6 alkynes, aromatics, halogens, carboxylic acid derivatives, sulfates and nitrates;

R₁ may be selected from, but is not limited to, the group consisting of N, NR5, NH, O, and carboxylic-acid derivatives, wherein R5 may be selected from the group consisting of H, C, C2-C6 alkanes, C2-C6 alkenes, C2-C6 alkynes, and aromatics.

Suitable monomers for use generally as crosslinking agents of the above general formula (2) include methylenebisacrylamide, ethylenebisacrylamide, any water-soluble N,N′-alkylidene-bis (ethylenically unsaturated amide), and 1,3,5-Triacryloylhexahydro-1,3,5-triazine. Such crosslinking monomers generally comprise about 0.01% to about 15%, preferably about 0.5% to about 5% , and more preferably about 1% to about 3% by weight, of the total monomer solution (prior to polymerization).

The water soluble or water swellable polymer, which acts as a reinforcing element, may comprise polysulfone (anionic), poly(sodium-4-styrenesulfonate), poly(vinyl alcohol), carboxymethyl cellulose, polysulfone (anionic), sodium salt of poly(styrenesulfonic acid-co-maleic acid), corn starch, any other water-soluble or water-swellable polymers, or combinations comprising at least one of the foregoing polymers. Such water soluble or water swellable polymers generally comprise about 0% to about 30%, preferably about 1% to about 10%, and more preferably about 1% to about 4% by weight, of the total monomer solution (prior to polymerization).

A polymerization initiator may also be included, such as ammonium persulfate, alkali metal persulfates and peroxides, other initiators, or combinations comprising at least one of the foregoing initiators. Such initiators may generally comprise about 0% to about 3% of the solution prior to polymerization. Further, an initiator may be used in combination with radical generating methods such as radiation, including for example, ultraviolet light, X-ray, γ-ray, and the like. However, the chemical initiators need not be added if the radiation alone is sufficiently powerful to begin the polymerization. Specific examples of suitable polymerization initiators include, but are not limited to, 1-phenyl-2-methyl-2-hydroxypropanone, ammonium persulfate, 4,4′-diazidostilbene-2,2′-disulfonic acid disodium salt, benzenediazonium 4-(phenylamino)-sulfate (1:1) polymer with formaldehyde, 2-(2-(vinyloxy)ethoxy)-ethanol. These initiators may be combined with charge-transfer compounds, such as triethanolamine, to enhance activity.

In addition, an acidity or alkalinity modifier may be included to neutralize the monomer solution. For example, when the monomer solution is acidic, an alkaline solution such as KOH may be added to neutralize the solution.

Polymerization is generally carried out at a temperature ranging from room temperature to about 130° C. In certain embodiments, polymerization is heat induced, wherein an elevated temperature, ranging from about 75° to about 100° C., is preferred. Optionally, the polymerization may be carried out using radiation in conjunction with heating. Alternatively, the polymerization may be performed using radiation alone without raising the temperature of the ingredients, depending on the strength of the radiation. Examples of radiation types useful in the polymerization reaction include, but are not limited to, ultraviolet light, gamma rays, x-rays, electron beam, or a combination thereof.

In certain embodiments, water may be used as substantially the only liquid species added to the monomer solution. The water serves to create the matrix structure, thus acting as a space holder to increase the volume of the cured polymer. Thus, the polymer matrix volume may be defined with a specific amount of water. Generally, water comprises about 50% to about 90%, on a weight basis, preferably about 60% to about 80%, and more preferably about 62% to about 75% of the polymer matrix material.

In one method of forming the polymeric material the monomer solution, and an optional polymerization initiator is polymerized by heating, irradiating with ultraviolet light, gamma-rays, x-rays, electron beam, or a combination thereof, wherein a polymer matrix material is produced. When the ionic species is included in the polymerized solution, the hydroxide ion (or other ions) remains in solution after the polymerization. Further, to change or add a desired solution to the polymer matrix, the desired solution may be added to the polymer matrix, for example, by soaking the polymer matrix therein.

The polymer matrix material is generally be in the form of a hydrogel material with high conductivities, particularly at room temperature. The material possesses a definite macrostructure (i.e., form or shape). Further, the material does not recombine, for example, if a portion of the polymer matrix material is cut or otherwise removed, physically recombining them is typically not accomplished by mere contact between the portions, and the portions remain distinct. This is in contrast to gelatinous materials (e.g., Carbopol® based materials), which are typically fluid and have no independent macrostructure, and recombination of several separated portions results in an indistinguishable mass of material.

Generally, the ionic conductivities are greater than about 0.1 S/cm, preferably greater than about 0.2 S/cm, and more preferably greater than about 0.4 S/cm. It is important to note that unexpectedly high ionic conductivities (up to 0.45 S/cm thus far), but not previously observed in conventional systems have been achieved using the polymer matrix membrane in the electrochemical cells described herein. This is, in part, because the electrolyte remains in solution phase within the polymer matrix.

The anode material, as described above, is a mixture of the metal constituent and the polymer matrix electrolyte material. The polymer matrix material may be combined with the metal constituent by any suitable methods, generally to provide a substantially homogeneous mixture. The polymer matrix material may be pre-ground, i.e., prior to mixing with the metal constituent. In other embodiments, the polymer matrix material is ground within the mixing process with the metal constituent, wherein the metal constituent serves as abrasive or cutting materials and the polymer matrix material generally winds up in a particulate or fibrous form.

An anode current collector may be provided, which can be any electrically conductive material capable of providing electrical conductivity and optionally capable of providing support to the anode 12. The current collector may be in the form of a mesh, porous plate, metal foam, strip, wire, foil, plate, or other suitable structure. The current collector may be formed of various electrically conductive materials including, but not limited to, copper, plated ferrous metals such as stainless steel, tin, brass, lead, silver, and the like, and combinations and alloys comprising at least one of the foregoing materials.

An optional binder may also be employed primarily to maintain the constituents of the anode in a solid or substantially solid form. The binder may be any material that generally adheres the metal constituent, the current collector, and the ionic conducting medium form a suitable structure, and is generally provided in an amount suitable for adhesive purposes of the anode. This material is preferably chemically inert to the electrochemical environment. In certain embodiments, the binder material also has hydrophilic characteristics. Appropriate binder materials include, but are not limited to, polyhydric alcohols such as glycerin, petrolatum (mineral oil), halocarbon oils, the like, and derivatives, combinations and mixtures comprising at least one of the foregoing binder materials. However, one of skill in the art will determine that other binder materials may be used.

Optional additives may be provided to prevent corrosion. Suitable additives include, but are not limited to indium oxide; zinc oxide, EDTA, surfactants such as sodium stearate, potassium Lauryl sulfate, Triton® X-400 (available from Union Carbide Chemical & Plastics Technology Corp., Danbury, Conn.), and other surfactants; the like; and derivatives, combinations and mixtures comprising at least one of the foregoing additive materials. However, one of skill in the art will determine that other additive materials may be used.

The oxygen supplied to the cathode 14 may be from any oxygen source, such as air; scrubbed air; pure or substantially oxygen, such as from a utility or system supply or from on site oxygen manufacture; any other processed air; or any combination comprising at least one of the foregoing oxygen sources.

Cathode 14 may be a conventional air diffusion cathode, for example generally comprising an active constituent and a carbon substrate, along with suitable connecting structures, such as a current collector. Typically, the cathode catalyst is selected to attain current densities in ambient air of at least 20 milliamperes per squared centimeter (mA/cm²), preferably at least 50 mA/cm², and more preferably at least 100 mA/cm². Of course, higher current densities may be attained with suitable cathode catalysts and formulations, and varying degrees of oxygen purity and pressure. The cathode 14 may be mono-functional, that is, designed for discharging cells. A mono-functional cathode may be used alone, for example, in a primary cell, or alternatively in conjunction with a third charging electrode, for example in a rechargeable cell. Alternatively, the cathode 14 may be a bi-functional, for example, which is capable of both operating during discharging and recharging. An exemplary air cathode is disclosed in copending, commonly assigned U.S. Pat. No. 6,368,751, entitled “Electrochemical Electrode For Fuel Cell”, to Wayne Yao and Tsepin Tsai, granted on Apr. 9, 2002, which is incorporated herein by reference in its entirety. Other air cathodes may instead be used, however, depending on the performance capabilities thereof, as will be obvious to those of skill in the art.

The carbon used is preferably be chemically inert to the electrochemical cell environment and may be provided in various forms including, but not limited to, carbon flake, graphite, other high surface area carbon materials, or combinations comprising at least one of the foregoing carbon forms. The cathode current collector may be any electrically conductive material capable of providing electrical conductivity and optionally capable of providing support to the cathode 14. The current collector may be in the form of a mesh, porous plate, metal foam, strip, wire, foil, plate, or other suitable structure. In certain embodiments, the current collector is porous to minimize oxygen flow obstruction. The current collector may be formed of various electrically conductive materials including, but not limited to, nickel. Nickel plated ferrous metals such as stainless steel, and the like, and combinations and alloys comprising at least one of the foregoing materials. Suitable current collectors include porous metal such as nickel foam metal.

A binder is also typically used in the cathode 14, which may be any material that adheres substrate materials, the current collector, and the catalyst to form a suitable structure. The binder is generally provided in an amount suitable for adhesive purposes of the diluent, catalyst, and/or current collector. This material is preferably chemically inert to the electrochemical environment. In certain embodiments, the binder material also has hydrophobic characteristics. Appropriate binder materials include polymers and copolymers based on polytetrafluoroethylene (e.g., Teflon® powder or emulsions such as and Teflon® T-30 commercially available from E. I. du Pont Nemours and Company Corp., Wilmington, Del.), sulfonic acid (e.g., Nafion® commercially available from E. I. du Pont Nemours and Company Corp.), polyvinylidene fluoride (PVDF), polyethylene fluoride (PEF), and the like, and derivatives, combinations and mixtures comprising at least one of the foregoing binder materials.

The active constituent is generally a suitable catalyst material to facilitate oxygen reaction at the cathode 14. The catalyst material is generally provided in an amount suitable to facilitate oxygen reaction at the cathode 14. Suitable catalyst materials include, but are not limited to: manganese and its compounds, cobalt and its compounds, platinum and its compounds, and combinations comprising at least one of the foregoing catalyst materials.

To electrically isolate the anode 12 from the cathode 14, the separator 16 is provided between the electrodes. In the cell 10 herein, the separator 16 is disposed on the anode 12 to at least partially contain the anode constituents. Separator 16 may be any commercially available separator capable of electrically isolating the anode 12 and the cathode 14, while allowing sufficient fluid and ionic transport between the anode 12 and the cathode 14. Preferably, the separator is flexible, to accommodate electrochemical expansion and contraction of the cell components, and chemically inert to the cell chemicals. Suitable separators are provided in forms including, but not limited to, woven, non-woven, porous (such as microporous or nanoporous), cellular, polymer sheets, and the like. Materials for the separator include, but are not limited to, polyolefin (e.g., Gelgard® commercially available from Celgard LLC, Charlotte, N.C.), polyvinyl alcohol (PVA), cellulose (e.g., cellophane, cellulose acetate, and the like), polyamide (e.g., nylon), fluorocarbon-type resins (e.g., the Nafion® family of resins which have sulfonic acid group functionality, commercially available from DuPont Chemicals, Wilmington, Del.), filter paper, and combinations comprising at least one of the foregoing materials. The separator may also comprise additives and/or coatings such as acrylic compounds and the like to make them more wettable and permeable to the electrolyte. The separator may also comprise additives and/or coatings such as acrylic compounds and the like to make them more wettable and permeable to the electrolyte. Further, the separator 16 may comprise a solid-state membrane, such as described in copending, commonly assigned U.S. Pat. No. 6,183,914; U.S. patent application Ser. No. 09/259,068; and U.S. Pat. No. 6,358,651, which are all incorporated herein by reference in their entireties and referenced above.

In certain cell configurations, the efficiency of discharge of the anode material may be increased with compression the cell structure. For example, a force may be exerted on one or both sides of the cell. Further, one or more weights may be included to impart pressure on the anode material. Various configurations may be used.

The anode material described herein and claimed below has many advantages as compared to conventional anode materials. The material itself provides electrolyte with high conductivity and resembles a moist sand that is generally gray in color, for example, with zinc, and white in color, for example, with zinc oxide. However, the material is solid state and non-leaking. To provide ionic mobility, the electrolyte therein is aqueous, and remains non-leaking due to the polymer matrix material's molecular structure. The anode material may be used in primary cells or rechargeable cells, depending on the formulation. For example, in rechargeable cells, the metal constituent of the anode material is preferably metal oxide (optionally including metal), which is converted to metal during recharging. In primary cells, the metal constituent of the anode material is preferably metal.

While preferred embodiments have been shown and described, various modifications and substitutions may be made thereto without departing from the spirit and scope of the invention. Accordingly, it is to be understood that the present invention has been described by way of illustrations and not limitation.

What is claimed is:

1. An anode material for a metal air electrochemical cell comprising a mixture of:
metal particles, metal oxide particles, or metal particles and metal oxide particles; and
an ion conducting material comprising a polymer matrix material including electrolyte supported within the molecular structure of the polymer matrix material.

2. The anode material as in claim 1, wherein the metal or metal oxide particles are selected from the group of materials consisting of zinc, calcium, magnesium, ferrous metals, aluminum and combinations and alloys comprising at least one of the foregoing metals.

3. The anode material as in claim 1, wherein the ionic conducting material comprises a polymer matrix material and a source of hydroxide ions.

4. The anode material as in claim 3, wherein the polymer matrix material comprises a polymerization product of one or more monomers selected from the group of water soluble ethylenically unsaturated acids and acid derivatives.

5. The anode material as in claim 4, wherein the polymer matrix material further comprises a water soluble or water swellable polymer.

6. The anode material as in claim 5, wherein the polymer matrix material further comprises a chemical polymerization initiator.

7. The anode material as in claim 4, wherein the source of hydroxide ions is added prior to polymerization.

8. The anode material as in claim 4, wherein the source of hydroxide ions is added after polymerization.

9. A metal air electrochemical cell comprising:
a quantity of the anode material of claim 1;
an air cathode; and
a separator between the quantity of anode material and the air cathode.

10. The metal air electrochemical cell of claim 9, further comprising an apparatus or object for providing force to maintain physical contact between the anode material, the separator, and the air cathode.

11. The metal air electrochemical cell of claim 9, further comprising a weight on a side of the anode material opposite the separator.
